(19) United States
(12) Patent Application Publication
(10) Pub. No.: US 2026/0024675 A1
(43) Pub. Date: Jan. 22, 2026

(54) SHIELDING ELEMENT FOR X-RAY RADIATION WITH A LEAD SUBSTITUTE

(71) Applicant: Siemens Healthineers AG, Forchheim (DE)

(72) Inventors: Christian HOFFMANN, Adelsdorf (DE); Michael KRAUS, Forchheim (DE)

(73) Assignee: Siemens Healthineers AG, Forchheim (DE)

(21) Appl. No.: 19/267,697

(22) Filed: Jul. 14, 2025

(30) Foreign Application Priority Data
Jul. 16, 2024 (EP) 24188905.4

(51) Int. Cl. G21F 1/08

(52) U.S. Cl. CPC G21F 1/08

(57) ABSTRACT

A shielding element for shielding X-ray radiation has a base body. The base body includes a composite material which contains a plastic containing a powder of a metal to absorb the X-ray radiation, the base body is coated via a closed layer of a conductive material such that the base body is completely encased by the layer of conductive material.

### CROSS-REFERENCE TO RELATED APPLICATION(S)

The present application claims priority under 35 U.S.C. § 119 to European Patent Application No. 24188905.4, filed Jul. 16, 2024, the entire contents of which are incorporated herein by reference.

Independent of the grammatical term usage, individuals with male, female or other gender identities are included within the term.

### FIELD

One or more example embodiments is based on a shielding element for shielding X-ray radiation,
wherein the shielding element has a base body,
wherein the base body consists of a composite material which contains a plastic, in which a powder of a metal is contained, via which the X-ray radiation can be absorbed.

### RELATED ART

Shielding elements are generally known. By way of example, in this regard WO 2005/024 846 A1, US 2007/0 145 294 A1 and WO 2021/165 988 A1 can be cited.

X-ray radiation is used in many areas. By way of example, industrial applications in rolling mills are known, via which the thickness of a rolled material is determined. However, X-ray radiation is primarily used in the medical field, for instance in C-arm systems and CT systems.

In order to protect individuals, for instance medical personnel, and where possible also an examined person, X-ray radiation is shielded as far as possible so that the individuals are only exposed to the ionizing X-ray radiation in the range in which it is absolutely necessary.

Materials containing a significant amount of lead have been used to shield X-ray radiation for many years. In this regard, lead has various advantageous properties. On the one hand it is therefore resistant to X-ray radiation and furthermore has a high absorption capacity for X-ray radiation. Furthermore, it is oil-resistant which is advantageous when used in some environments and may even be obligatory. Furthermore, it has a high electrical conductivity and can be easily electrically contacted. Furthermore, lead is relatively soft and can be machined in a simple manner. Lead nevertheless has the key disadvantage that it is harmful to health. In many industrial applications, the use of lead as a shielding material is therefore no longer permissible. It is still permitted for radiation protection in medical technology. However, efforts are currently underway to no longer permit lead in medical applications.

Other substances, in particular metals, which are resistant to X-ray radiation, effectively absorb X-ray radiation and are oil-resistant in a similar manner to lead, are known. These other substances are referred to below as lead substitutes. By way of example, tungsten comes into consideration. However, the lead substitutes are sometimes harmful to health in a similar manner to lead. If a lead substitute is harmful to health, replacing lead with a lead substitute of this type is pointless. Other lead substitutes are in fact not toxic, but are disadvantageous in that they cannot be processed and machined mechanically or only with significant difficulty.

It is known from the prior art—see the afore-cited patent publications—to embed lead substitutes in powder form into a radiation-resistant polymer matrix and thus to create a composite material. With a correspondingly high fill level of the lead substitute, it is possible to achieve a strong capability to absorb X-ray radiation. The composite material can be easily processed and machined on account of the powder form and the embedding into the polymer matrix.

The composite material thus created and the shielding element produced therefrom are therefore in fact resistant with respect to the X-ray radiation and also have a high absorption capacity for X-ray radiation. Furthermore, they can be processed and machined easily. Most composite materials of this type are not resistant to oil, however. Furthermore, they are electrically insulating or only have a minimal electrical conductivity. In some cases, electrical contacting is moreover also not possible. Connecting the shielding element to a defined potential is therefore not possible or only with difficulty. This may in particular result in problems if the shielding element is arranged in the vicinity of the high voltage field. Furthermore, in this case the shielding element can influence the trajectory of the electrons in the X-ray tube via static charging. Finally, it must also be possible to safely deflect potential flashovers of the high voltage into the composite material.

### SUMMARY

One or more example embodiments creates possibilities via which the disadvantages of the prior art are eliminated.

The is achieved by a shielding element having the features of claim 1. Advantageous embodiments of the shielding element form the subject matter of the dependent claims 2 to 13.

### BRIEF DESCRIPTION OF THE DRAWINGS

The properties, features and advantages as well as the manner in which these are achieved will become clearer and more intelligible in conjunction with the following description of the exemplary embodiments, which are explained in conjunction with the drawings. These show in a schematic representation:

FIG. 1 illustrates an X-ray arrangement according to one or more example embodiments,

FIG. 2 illustrates a section through a shielding element according to one or more example embodiments,

FIG. 3 illustrates a top view onto a shielding element according to one or more example embodiments, and

FIG. 4 illustrates a section along a line IV-IV through the shielding element in FIG. 3.

### DETAILED DESCRIPTION

In accordance with one or more example embodiments, a shielding element of the type cited in the introduction is configured so that the base body is coated via a closed layer of conductive material, such that the base body is completely encased by the layer of conductive material.

On account of the casing, the base body itself (in other words the composite material) no longer comes into contact with oil. The fact that the base body itself is not oil-resistant is therefore further given. It is irrelevant, however, because the oil only comes into contact with the layer of the conductive material. Furthermore, the layer of the conductive material surrounds the base body and thus forms a Faraday cage around the base body. This namely also gives rise to the fact that the base body itself is not or only poorly electrically conducting. However, this is irrelevant because the base body is located in the Faraday cage. Furthermore, an electrical contacting of the layer of the conductive material is readily possible so that the shielding element can be readily connected to a defined potential. Finally, the high currents which occur when discharging (arcing) in the oil can be discharged via the Faraday cage without any problem.

The base body is preferably embodied as an injection molded part. As a result, it is possible to dispense with subsequent machining of the base body or at least reduce it to a minimum.

The composite material preferably consists of at least 90 percent by weight, preferably at least 95 percent by weight, and/or at least 30 percent by volume, preferably at least 40 percent by volume and in particular at least 50 percent by volume of the powder of the metal. As a result, the composite material can have a high absorption capacity for ionizing radiation.

The plastic which is contained in the composite material is preferably a thermoplastic, an elastomer or a thermosetting plastic (e.g., duroplast). PEEK and polyimide come into consideration as plastics, for instance.

As far as the functionality is concerned, the metal only needs to be resistant to X-ray radiation and have a high absorption capacity for X-ray radiation. Theoretically, the metal could therefore even be lead. Since lead is to be replaced via the composite material, this makes no sense, however. Instead, the metal is preferably a refractory metal. Refractory metals are the high melting point, base metals of the 4th subgroup, the 5th subgroup and the 6th subgroup of the periodic table, in other words titanium, zirconium and hafnium (4th subgroup), vanadium, niobium and tantalum (5th subgroup) as well as chromium, molybdenum and tungsten (6th subgroup).

The conductive material can be a metal, for instance aluminum, copper, silver, chromium, nickel-chromium, silver palladium or nickel gold, wherein aluminum is particularly preferred. A metal typically has a conductivity of 104 S/cm. It may however also be another metal or another material, which, in respect of its electrical conductivity, can be compared with a semiconductor. Its conductivity is typically below 10-8 S/cm. One example of such a semiconductive material is zinc oxide (ZnO).

The layer of conductive material preferably has a layer thickness of between 1 μm and 500 μm, in particular between 80 μm and 200 μm. A layer of conductive material with a layer thickness of this type can be produced easily.

Assuming a suitable application method, the layer can be applied at full thickness to the base body in a single work process. However, it is alternatively likewise possible to apply the layer in several work steps, wherein in each work step only one coating of the layer is applied with a relatively minimal individual thickness of the respective coating so that the layer thickness is the total of the individual thicknesses. If necessary, it is even possible for the coatings to consist of materials which differ from one another, for instance a lower priming coat comprising copper gold and a zinc layer applied thereabove.

The shielding element preferably comprises a contact, via which the layer of the conductive material can be connected to a defined potential, in particular to ground or earth. Alternatively, the defined potential can also be a high voltage potential, for instance the potential of the anode. It can however also be another high voltage potential, in particular a potential between the ground and the earth potential and the potential of the anode or the cathode. The contact can be in particular a solder contact or a screw contact. In the case of a screw contact, the base body can be what is known as an insert, which for its part makes available either a simple cutout or a thread. Furthermore, a clamping contact is also possible. The base body itself can also comprise a cutout. By way of example, an element (for instance a threaded bolt) can be guided through the cutout so that on the one side a bolt head of the threaded bolt rests in a pressurized manner on the layer applied there to the base body and on the other side a nut twisted onto the threaded bolt rests in a pressurized manner on the other side on the layer applied there to the base body. Finally, the contact can also be embodied differently, for instance as a plug-in contact or a welded contact. In the latter case, the contact can be applied or attached by spotwelding.

The layer of conductive material is preferably applied to the base body via galvanization, evaporation, immersion, submersion, spraying or coating. These techniques are relatively simple, reliable and cost-effective.

An oil-resistant sealant is preferably applied to the layer of conductive material in a local, planar or full-surface manner. As a result, the oil resistance can be improved still further.

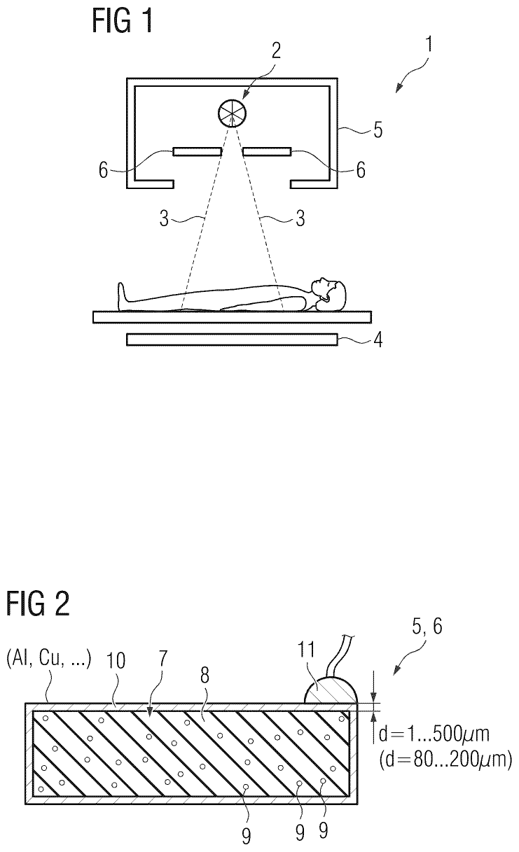

According to FIG. 1, an X-ray apparatus 1 has an X-ray source 2. X-ray radiation 3 is emitted via the X-ray source 2 and is detected via an X-ray detector 4.

To ensure that the X-ray radiation 3 only reaches the desired areas, the X-ray apparatus 1 has shielding elements 5, 6, via which the X-ray radiation 3 is shielded. The shielding elements 5, 6 can comprise an outer cladding 5, for instance, which surrounds the X-ray source 2 as a whole. The shielding elements 5, 6 can also comprise moveable diaphragm elements 6, via which a window is adjusted, from which the X-ray radiation 3 is to emerge.

FIG. 2 shows by way of example a shielding element 5, 6. According to FIG. 2, the shielding element 5, 6 has a base body 7. The base body 7 consists of a composite material which contains a plastic 8, in which a powder 9 of a metal is contained, via which the X-ray radiation 3 can be absorbed. The composite material can consist of at least 90 percent by weight, preferably at least 95 percent by weight and/or at least 30 percent by volume, preferably at least 40 percent by volume and in particular at least 50 percent by volume, of the powder 9 of the metal.

The plastic 8 can be a thermoplastic, an elastomer or a thermosetting plastic, for instance PEEK or a polyimide. The metal can be a refractory metal, for instance. The base body 7 can be embodied in particular as an injection molded part.

The base body 7 is coated via a closed layer 10 of conductive material, so that the base body 7 is completely encased by the layer 10 of conductive material. The conductive material can be a metal, in particular aluminum, copper, silver, chromium, nickel-chromium, silver palladium or nickel gold. It can also be a semiconductive material, for instance. The layer 10 preferably has a layer thickness d of between 1 μm and 500 μm, in particular between 80 μm and 200 μm. The layer 10 can be applied via galvanization, evaporation, immersion, brushing, spraying or coating the base body 7, for instance.

According to FIG. 2, the shielding element 5, 6 comprises a contact 11. The layer 10 can be connected to a defined potential via the contact 11. The defined potential can be in particular ground or earth. A high voltage potential also comes into consideration. According to FIG. 2, the contact 11 is a soldered contact.

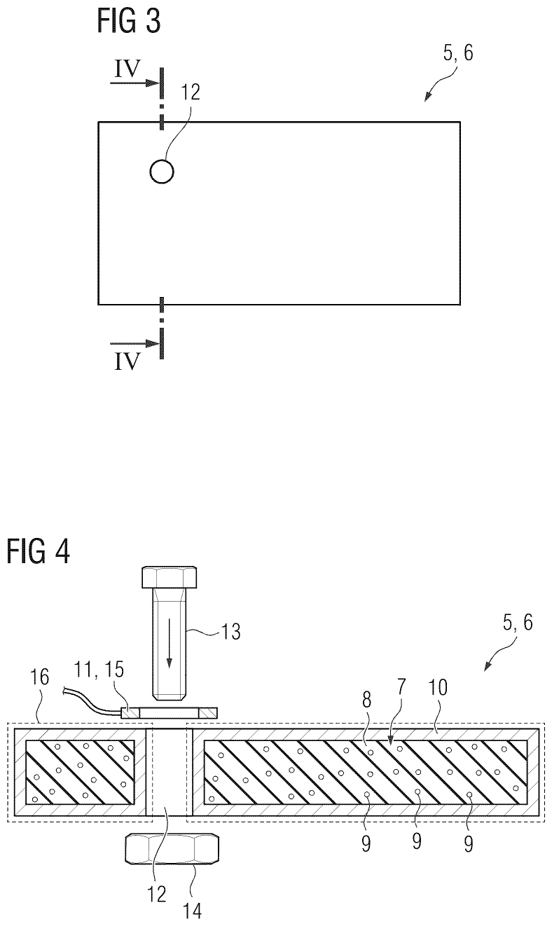

FIG. 3 shows a top view onto an alternative embodiment of the shielding element 5, 6. FIG. 4 shows a section along a line IV-IV in FIG. 3.

The embodiment of the shielding element 5, 6 in FIG. 3, 4 corresponds largely to the embodiment of the shielding element 5, 6 in FIG. 2. The essential difference is the embodiment of the contact 11. Specifically, the shielding element 5, 6 has a cutout 12, through which a screw 13 can be guided, which can be screwed into a nut 14 on the opposite side of the shielding element 5, 6. As a result, it is possible to push a cable shoe 15 onto the layer 10. The contact 11 of the embodiment in FIG. 3, 4 can be considered to be a screw contact or a clamping contact, if necessary.

FIG. 4 also shows a further modification of the shielding element 5, 6. This modification can also be realized in the case of the shielding element 5, 6 in FIG. 2. Specifically, an oil-resistant sealant 16 is applied to the layer 10. The sealant 16 is applied to the entire surface of the layer 10 in accordance with FIG. 4. It is also possible however to only apply the sealant 16 to the layer 10 locally (specifically at critical points).

One or more example embodiments has many advantages. The shielding element 5, 6 is made compactly. Its X-ray-specific properties can be compared with those of lead. The shielding element 5, 6 can be produced in a cost-effective and simple manner and can be used without further structural adjustments directly as a substitute for previous shielding elements made of lead. The ampacity of the layer 10 is high. As a result, the shielding element 5, 6 can even cope with flashovers (arcings). If necessary, it is even possible to connect several inventive shielding elements 5, 6 with one another, for instance via soldering. Small non-metallized regions at abutting edges can be ignored for instance or provided separately with a protective layer of the sealant 16.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Specific structural and functional details disclosed herein are merely representative for purposes of describing example embodiments. The present invention may, however, be embodied in many alternate forms and should not be construed as limited to only the embodiments set forth herein.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the invention has been illustrated and described in more detail by the preferred exemplary embodiments, the invention is not restricted by the disclosed examples and other variations can be derived herefrom by the person skilled in the art without departing from the scope of protection of the invention.

1. A shielding element configured to shield X-ray radiation, the shielding element comprising:
a base body, the base body including a composite material containing a plastic containing a powder of a metal to absorb the X-ray radiation, the base body is coated via a closed layer of a conductive material such that the base body is completely encased by the layer of conductive material.

2. The shielding element of claim 1, wherein the base body is an injection molded part.

3. The shielding element of claim 1, wherein the composite material consists of at least one of at least 90 percent by weight or at least 30 percent by volume of the powder of the metal.

4. The shielding element of claim 1, wherein the plastic is a thermoplast, an elastomer or a duroplast.

5. The shielding element of claim 1, wherein the metal is a refractory metal.

6. The shielding element of claim 1, wherein the conductive material is a metal.

7. The shielding element of claim 6, wherein the conductive material is aluminum, copper, silver, chromium, nickel chromium, silver palladium or nickel gold.

8. The shielding element of claim 1, wherein the conductive material is a semiconductive material.

9. The shielding element of claim 1, wherein the layer of conductive material has a layer thickness between 1 μm and 500 μm.

10. The shielding element of claim 1, wherein the shielding element comprises a contact connectable to a defined potential via the layer of the conductive material.

11. The shielding element of claim 10, wherein the contact is a soldered contact or a screw contact.

12. The shielding element of claim 1, wherein the layer of conductive material is applied to the base body via galvanization, evaporation, immersion, brushing, spraying or coating.

13. The shielding element of claim 1, wherein an oil-resistant sealant is applied to the layer of conductive material in a local, planar or full-surface manner.

14. The shielding element of claim 3, wherein the composite material consists of at least one of at least 95 percent by weight or at least 50 percent by volume of the powder of the metal.

15. The shielding element of claim 9, wherein the layer thickness is between 80 μm and 200 μm.

16. The shielding element of claim 10, wherein the defined potential is ground.

17. The shielding element of claim 4, wherein the conductive material is a metal.

18. The shielding element of claim 17, wherein the conductive material is aluminum, copper, silver, chromium, nickel chromium, silver palladium or nickel gold.

19. The shielding element of claim 4, wherein the conductive material is a semiconductive material.

20. The shielding element of claim 19, wherein the layer of conductive material has a layer thickness between 1 μm and 500 μm.
